(19) United States
(12) Patent Application Publication
(10) Pub. No.: US 2007/0168870 A1
(43) Pub. Date: Jul. 19, 2007

(54) Content management system and content management method

(75) Inventor: Hiroyuki Wada, Fuchu-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/716,551

(22) Filed: Mar. 12, 2007

Related U.S. Application Data
(63) Continuation of application No. PCT/JP06/22752, filed on Nov. 15, 2006.

(30) Foreign Application Priority Data
Nov. 15, 2005 (JP) 2005-330525

(51) Int. Cl. G06F 3/00; G06F 7/00; H04L 9/32

(52) U.S. Cl. 715/741; 707/102; 726/2

(57) ABSTRACT

A plurality of templates are provided in which, in the case of managing a work condition of a content editing work, a work item corresponding to a processing privilege assigned to each user is indicated. A template corresponding to the processing privilege of the user is registered in advance in a database together with user information. At the time of a user access to content editing, an accessing user is authenticated referring to the database, and if the accessing user is a registered user, the corresponding template is selected, and work items presented on the template are displayed. Then, execution of a work that corresponds to each one of the work items is grasped, and its work history is stored in the corresponding item of the template. When the same user access has occurred again, the work history is indicated on a template.

### CROSS-REFERENCE TO RELATED APPLICATIONS

This is a continuation Application of PCT Application No. PCT/JP2006/322752, filed Nov. 15, 2006, which was published under PCT Article 21(2) in Japanese.

This application is based upon and claims the benefit of priority from prior Japanese Patent Application No. 2005-330525, filed Nov. 15, 2005, the entire contents of which are incorporated herein by reference.

### BACKGROUND OF THE INVENTION

1. Field of the Invention

The present invention relates to a content management system and a content management method used for an authoring apparatus which carries out a work of editing a video image/voice contents for use in a broadcast program, for example, the system and method integrally managing a work situation.

2. Description of the Related Art

Conventionally, at a broadcast station, at the time of carrying out a work of editing a broadcast program, a whole system manages transition of one content by means of a dedicated application. However, the application of this type does not carry out management on a user by use basis. Thus, even in the case of using the contents previously worked by the user, there is a need for making a search from a recording medium every time, and a large amount of time is required for preparation before starting a work. In addition, it is difficult for the user to grasp a progress and, user's thought may be interrupted in the middle of a work routine, causing an occurrence of omitted work.

As a conventional technique of solving the problem of this type, there is provided a technique of efficiently managing a series of works in Jpn. Pat. Appln. KOKAI Publication No. 2005-258982. However, the technique described in this document enables a work before interrupted to be continuously carried out after the interruption in a distributed network system, in the case where a user uses different terminals before and after the interruption. The present invention is not limited to a distributed network system in particular. The present invention is featured in that a work progress can be always precisely grasped, thereby improving work efficiency.

### BRIEF SUMMARY OF THE INVENTION

It is an object of the present invention to provide a content management system and a content management method capable of displaying a work progress in units of users and a list of works to be carried out, thereby making it possible to achieve reduction of a preparatory work before starting work and reduction of omitted work.

According to the present invention, there is provided a content management system which manages a work situation with respect to a content editing device that carries out a work of editing contents, the system comprising: a database which registers in advance a user management table that indicates information including authentication identification information and processing privileges at the time of an access with respect to each one of registered users, and a content management table that indicates, as work information on the contents, a work item that can be processed for each processing privilege and a work situation of each one of the work items in a format of template; authentication means for, when an access has been made to the content editing device, authenticating an accessing user by referring to the user management table of the database; processing privilege judgment means for, if the accessing user is the registered user, judging a processing privilege assigned to the registered user by referring to the user management table; template selection means for selecting a template that corresponds to the processing privilege judged by the judgment means by referring to the content management table; and template update means for displaying a work item indicated by the template, grasping execution of a work corresponding to each one of the work items, and storing a work history thereof in a corresponding item of the template, wherein the template update means indicates the work history in the corresponding item of the template at the time of an access from the same user.

In addition, according to the present invention, there is provided a content management method for managing a work situation with respect to a content editing device that carries out a work of editing contents, the method comprising: registering in advance in a database a user management table that indicates information including authentication identification information and processing privileges at the time of an access with respect to each one of registered users, and a content management table that indicates, as work information on the contents, a work item that can be processed for each processing privilege and a work situation of each one of the work items in a format of template; when an access has been made to the content editing device, authenticating an accessing user by referring to the user management table in the database; if the user turns out to be a registered user as a result of the authentication, judging a processing privilege assigned to the registered user by referring to the user management table; selecting a template that corresponds to the judged processing privilege by referring to the content management table; displaying a work item indicated by the selected template, grasping execution of a work that corresponds to each one of the work items, and storing the work history in a corresponding item of the template; and when an access from the same user has been made again, displaying the work item including the work history on the template.

### BRIEF DESCRIPTION OF THE SEVERAL VIEWS OF THE DRAWING

FIG. 1 is a block diagram depicting an embodiment of a content management system according to the invention;

FIG. 2 is a view showing an example of a user management table registered in a database device of the system shown in FIG. 1;

FIG. 3 is a view showing an example of a content management table registered in the database device of the system shown in FIG. 1;

FIG. 4 is a flow chart showing a flow of a series of processing operations in the system shown in FIG. 1; and

FIG. 5 is a view showing an example of a template display screen for carrying out content management on a user by user basis in the system shown in FIG. 1.

### DETAILED DESCRIPTION OF THE INVENTION

Hereinafter, an embodiment of the present invention will be described in detail with reference to the accompanying drawings.

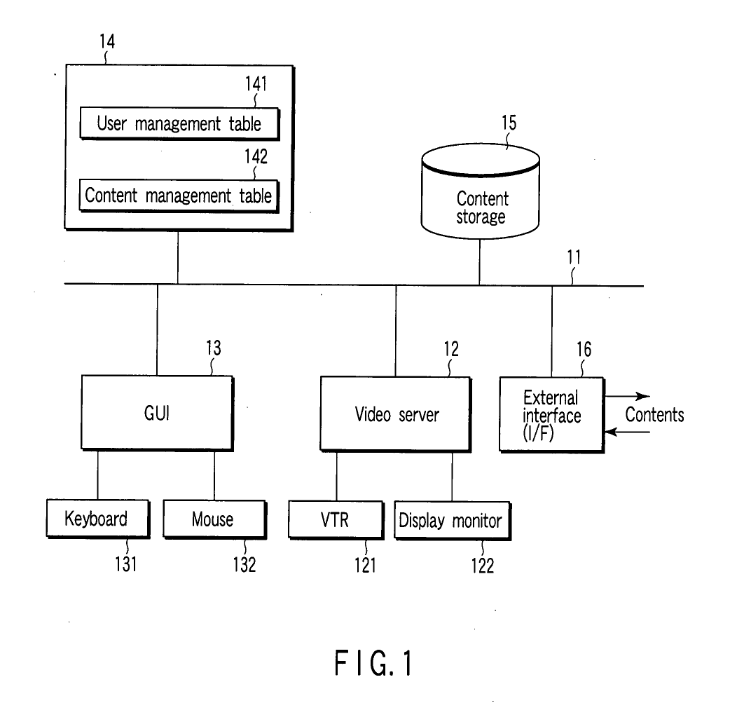

FIG. 1 is a block diagram depicting an embodiment of a content management system according to the present invention. In FIG. 1, reference numeral 11 denotes a bus. To this bus 11, there are connected: a video server 12 for content edit processing; a graphical user interface (GUI) unit 13; a database unit (DB) 14 for storing user information and work information; and a content storage unit 15 for temporarily storing contents for the purpose of work. Further, an external interface unit (external I/F) 16 for exchanging contents with an external content recording unit is connected to the above bus.

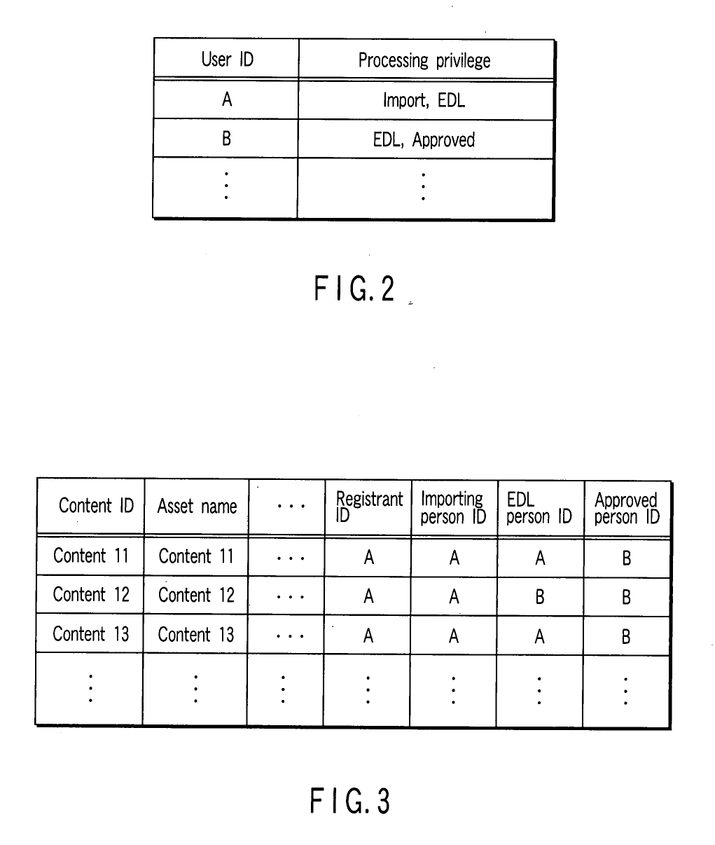

A content recording unit 121 such as a video tape recorder (VTR) and a display monitor unit 122 are connected to the above video server 12. In addition, operating input terminals such as a keyboard 131 and a mouse 132 are connected to the GUI unit 13. In addition, the database device 14 registers a user management table 141 including: information such as a login identification code (ID); authentication identification information, such as password, at the time of an access; and a processing privilege, as information for specifying a registered user in advance, and registers a content management table 142 indicating a work item that can be processed for each processing privilege and a list of work situations as work information on contents. FIG. 2 shows an example of the user management table 141 and FIG. 3 shows an example of the content management table 142.

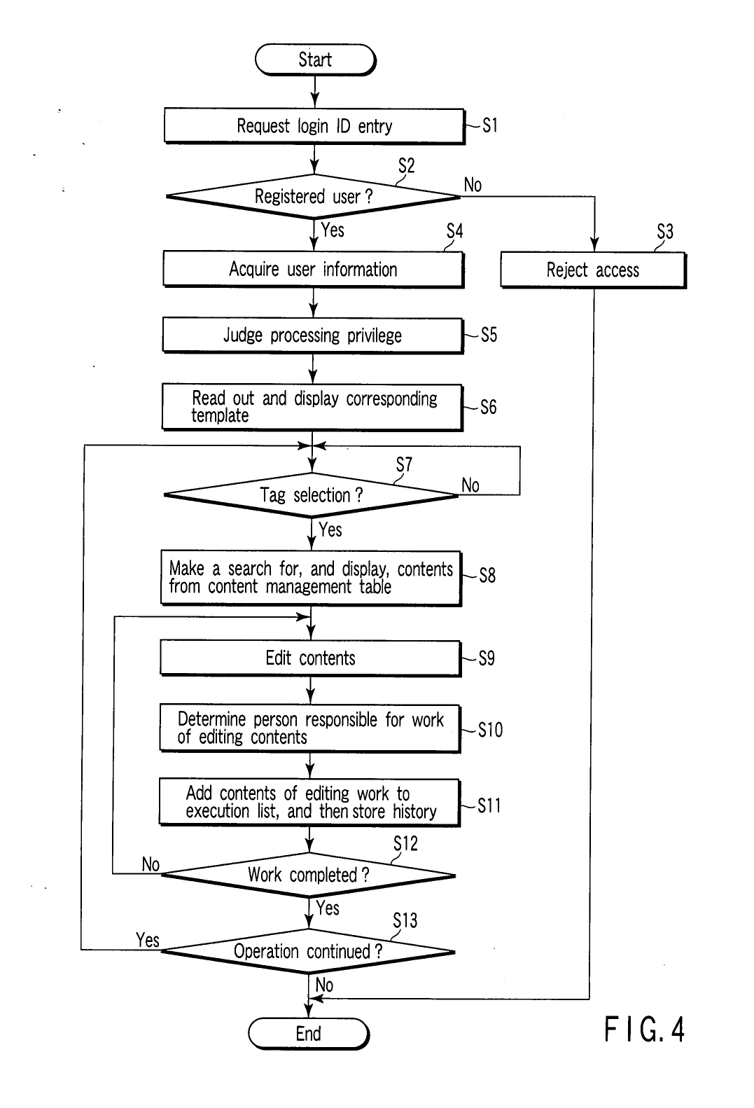

In the configuration described above, a content management technique according to the present invention will be described with reference to FIG. 4. FIG. 4 is a flow chart showing a flow of a series of processing operations in the content management technique described above.

In FIG. 4, in the case where execution of editing contents of a broadcast program has been instructed, a login screen is started, and then, a user is requested to enter a login ID (step S1). In the case where the login ID has been entered, it is judged whether or not the entered login ID belongs to a registered user by referring to the user management table 141 of the database device 14 (step S2). If the judgment result is negative, the access is rejected (step S3). When the judgment result is affirmative, user information is acquired from the user management table 141 (step S4). Then, a processing privilege registered as user information is judged (step 5). Then, a corresponding template of the work item list is read out from the content management table 142 to be displayed (step S6).

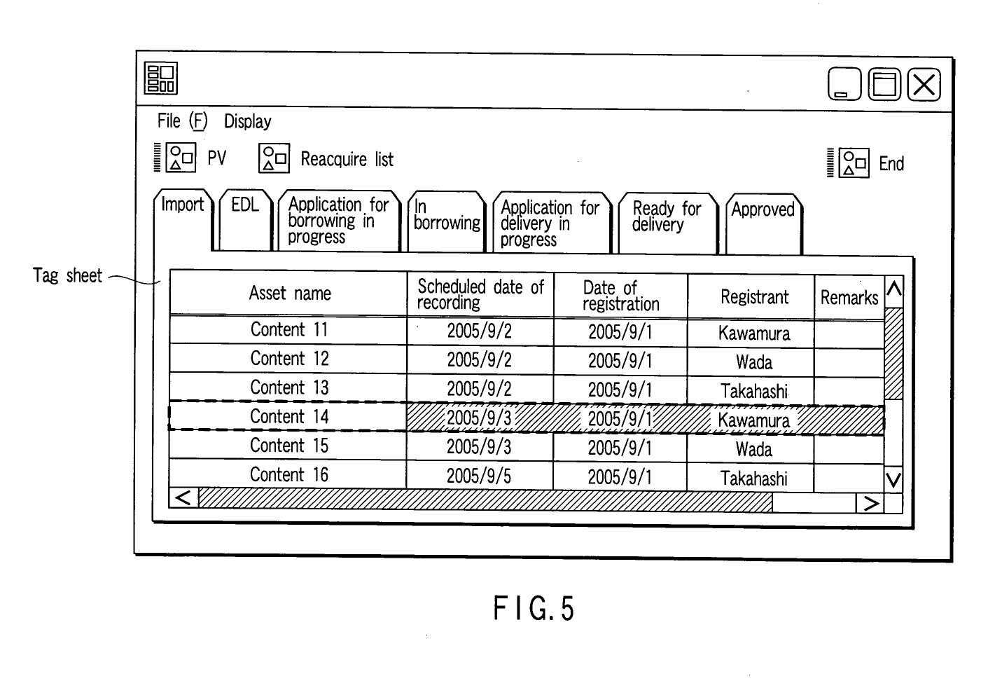

FIG. 5 shows an example of a template display screen for managing contents on a user by user basis. In this example, there is shown a work item list in the case where a login user has all processing privileges. In a template display format shown in this example, work items each are displayed in a superimposed manner in time series on a tag sheet. That is, the work items include: information relating to import contents recorded in the video server 12 (such as asset name, scheduled date of recording, date of registration, registrant, or remarks) (Tag: Import); a list showing an edit result (Tag: EDL (Edit Decision List)); a list of contents applied for borrowing (Tag: Application for borrowing in progress); a list of contents being currently borrowed (Tag: In borrowing); a list of contents applied for delivery (Tag: Applied for delivery); a list of contents ready for delivery (Tag: Ready for delivery); and a list of contents finally approved for delivery (Tag: Approved). In the case where the processing privilege of the login user is limited, a tag sheet of processing that is not permitted is erased so as not to make a display unnecessary for the user.

After a tag sheet has been displayed on the template display screen described above, the system waits for the user's tag selection operation (step S7). In the case where any selection operation has been made, a search is made for contents for which a login user is responsible, the login user having selected a tag from the content management table 142 (step S8), and then, the current processing moves to a work of editing the selected content (step S9). When the end of the editing work has been instructed, a person responsible for a work of the edited content is determined (step S10). Then, the content of the work in progress is added to an execution list, and the corresponding history is stored (written into a tag sheet) (step S11). Here, the completion of the work is verified (step S12). In the case where the work has not been completed, the current processing reverts to step S9, and then, moves to the work of editing contents. In the case where the work has been completed, an operation of selecting whether or not operation continues is judged (step S13). If continuation of the work is instructed, the current processing moves to step S7. If the end of the work is instructed, the result is logoff, and then, a series of processing operations is terminated.

According to the content management method described above, a list of contents is displayed on a work by work basis carried out by the login user (such as import tag, EDL tag, delivery ready tag, or approved tag shown in FIG. 5), and then, a list of progresses of the works carried out by the user is displayed similarly (such as a tag indicating application for borrowing in progress, a tag indicating borrowing in progress, or a tag indicating delivery application in progress shown in FIG. 5). Therefore, a desired work is selected from each list, and then, arbitrary contents are specified, thereby making it possible to start the work immediately, and restart an interrupted work. As a result, reduction of a preparation time for each work can be achieved more remarkably as compared with the conventional management method. In addition, the required work contents are presented on a user by user basis, whereby work omission can be reduced remarkably, and a fatal content delivery error can be prevented.

The present invention is preferably used for an authoring device that carries out a work of editing contents for use in a broadcast program.

What is claimed is:

1. A content management system which manages a work situation with respect to a content editing device that carries out a work of editing contents, the system comprising:
a database which registers in advance a user management table that indicates information including authentication identification information and processing privileges at the time of an access with respect to each one of registered users, and a content management table that indicates, as work information on the contents, a work item that can be processed for each processing privilege and a work situation of each one of the work items in a format of template;
authentication means for, when an access has been made to the content editing device, authenticating an accessing user by referring to the user management table of the database;
processing privilege judgment means for, if the accessing user is the registered user, judging a processing privilege assigned to the registered user by referring to the user management table;
template selection means for selecting a template that corresponds to the processing privilege judged by the judgment means by referring to the content management table; and
template update means for displaying a work item indicated by the template, grasping execution of a work corresponding to each one of the work items, and storing a work history thereof in a corresponding item of the template, wherein
the template update means indicates the work history in the corresponding item of the template at the time of an access from the same user.

2. The content management system according to claim 1, wherein the template is produced so as to prepare a tag sheet for each work item and to display a plurality of tag sheets to be arranged in time series.

3. A content management method for managing a work situation with respect to a content editing device that carries out a work of editing contents, the method comprising:
registering in advance in a database a user management table that indicates information including authentication identification information and processing privileges at the time of an access with respect to each one of registered users, and a content management table that indicates, as work information on the contents, a work item that can be processed for each processing privilege and a work situation of each one of the work items in a format of template;
when an access has been made to the content editing device, authenticating an accessing user by referring to the user management table in the database;
if the user turns out to be a registered user as a result of the authentication, judging a processing privilege assigned to the registered user by referring to the user management table;
selecting a template that corresponds to the judged processing privilege by referring to the content management table;
displaying a work item indicated by the selected template, grasping execution of a work that corresponds to each one of the work items, and storing the work history in a corresponding item of the template; and
when an access from the same user has been made again, displaying the work item including the work history on the template.

4. The content management method according to claim 3, wherein the template is produced so as to prepare a tag sheet for each work item and to display a plurality of tag sheets to be arranged in time series.
